(19) United States
(12) Patent Application Publication
(10) Pub. No.: US 2011/0251873 A1
(43) Pub. Date: Oct. 13, 2011

(54) METHOD, SYSTEM, AND COMPUTER READABLE RECORDING MEDIUM FOR GENERATING KEYWORD PAIRS FOR SEARCH ADVERTISEMENTS BASED ON ADVERTISEMENT PURCHASE HISTORY

(75) Inventors: Yoon Young Jung, Seoul (KR); Jae Keol Choi, Seoul (KR); Ar Reum Song, Seoul (KR); Jae Eun Kim, Seoul (KR)

(73) Assignee: NHN BUSINESS PLATFORM CORPORATION, Seongnam-si (KR)

(21) Appl. No.: 13/123,461

(22) PCT Filed: Oct. 9, 2009
(86) PCT No.: PCT/KR09/05780

§ 371 Date: Jun. 29, 2011

(30) Foreign Application Priority Data
Oct. 9, 2008 (KR) 10-2008-0099096

(51) Int. Cl. G06Q 30/00

(52) U.S. Cl. 705/7.29

(57) ABSTRACT

The present disclosure relates to a method, system and computer readable recording medium for generating a keyword pair for search advertisement based on advertisement purchase history. The method includes acquiring a set of search keywords for each of advertisers having purchased or attempted to purchase the search keywords to place search advertisement or to make an attempt to place the search advertisement, selecting at least two search keywords among the set of keywords, generating a keyword pair of the selected search keywords correlated to each other, and storing information regarding the generated keyword pair. It is possible to provide an improved keyword determination model capable of determining correlated search keywords without processing an enormous amount of data such as search keywords of all users or keywords appearing on all of web pages, thereby enabling more efficient data processing.

### BACKGROUND

1. Technical Field

The present disclosure relates to a method, system and computer readable recording medium for generating a keyword pair for search advertisement based on an advertisement purchase history. More particularly, the present disclosure relates to a method, system and computer readable recording medium for generating a keyword pair according to the number of advertisers, for example, who purchase or attempt to purchase two keywords for search advertisement at the same time.

2. Description of the Related Art

Recently, with generalization of the Internet, users can obtain information through Internet search. Users can connect to an Internet search site through a terminal such as a personal computer connected to the Internet and search for various kinds of content, for example, news, knowledge, games, and communities.

As such, with generalization of information acquisition through Internet search, search advertisement to supply advertisement related to a search word, for example, search keyword input from a user through a search site, has recently been introduced. Here, search advertisement refers to an advertising technique which allows advertisement information, for example, the web page address of an advertiser, a single line advertisement message, and an advertising image to appear at a certain position on a search result page when a user searches for information using a certain word through a search engine. Further, according to such search advertisement, since advertisement is supplied to a person searching for information using a search word correlated to a certain advertisement instead of being unconditionally provided to unspecified persons, it is advantageous in that targeted advertisement is supplied only to potential customers who have a relatively high possibility of using products or services supplied by the advertiser, so that the search advertisement has attracted remarkable attraction and is increasingly used in the related art.

On the other hand, in view of advertisers paying for search advertisements, it is is very important to determine proper search keywords such that the search advertisement can be effectively exposed to users. Therefore, in order to allow advisers to designate or choose keywords according to such needs of the advertisers, managers of search sites provide an interface which allows advisers to acquire bidding information regarding search keywords that advertisers want to purchase, and a function of recommending search keywords related to search keywords that advertisers want to purchase.

As a conventional technique of determining correlated search keywords, there is a technique of analyzing search keywords input to a search site by users. More specifically, when there is high tendency of simultaneously or sequentially inputting two or more search keywords to search for certain information, the corresponding search keywords are determined as correlated search keywords.

As another conventional technique of determining correlated search keywords, there is a technique of analyzing keywords appearing on web pages provided by a search site. More specifically, a number of frequencies of plural keywords appearing on web pages are recorded, and when there is high tendency of a set of certain keywords appearing on a common web page, the keywords are determined as the correlated search keywords.

According to a technique of determining the correlated search keywords, since the correlated search keywords are used together by users or determined according to the frequency is of appearing together on the web page, correlated search keywords can be advantageously determined based on general data, but there is also a severe side effect. For example, since it is necessary for the conventional techniques to analyze keywords input by all users or keywords appearing on all web pages, the amount of data to be analyzed excessively increases, thereby causing significant cost increase in terms of time and system resources. Moreover, since the conventional techniques determine the correlated search keyword irrespective of advertiser preference, it is difficult to reflect advertiser preference or purchase pattern.

### BRIEF SUMMARY

The present disclosure is directed to solving the problems of the conventional technique as described above.

The present disclosure is also directed to providing a model for determining correlated search keywords without processing an enormous amount of data such as search keywords of all users or keywords appearing on all web pages.

The present disclosure is also directed to providing methods and systems capable of determining more reasonably correlated search keywords reflecting advertiser preference or purchase pattern.

In accordance with one aspect of the present disclosure, a method of generating correlated information between search keywords includes: acquiring a set of search keywords for each of advertisers having purchased or attempted to purchase the search keywords to place search advertisement or to make an attempt to place the search advertisement; selecting at least two search keywords among the set of keywords; generating a keyword pair of the selected search keywords correlated to each other; and storing information regarding the generated keyword pair.

In accordance with another aspect of the present disclosure, a method of providing information regarding correlated keywords related to search keywords that an advertiser wants to purchase is provided. The method includes receiving information regarding a first search keyword from a specific advertiser; acquiring a second search keyword related to the first search keyword, the second search keyword being a search keyword that any other advertiser having purchased or attempted to purchase the first search keyword has purchased or attempted to purchase; and providing information regarding the acquired second search keyword to the specific advertiser.

In accordance with a further aspect of the present disclosure, a system for generating correlated information between search keywords includes: an advertiser interface unit providing an interface which allows advertisers to purchase the right to place search is advertisement therethrough; a history database storing history of a series of behaviors performed by advertisers upon inquiry about and purchase of search keywords through the advertiser interface unit; a history analyzer which acquires, from the history database, a set of search keywords that a certain advertiser has purchased or attempted to purchase, selects at least two search keywords among the set of keywords, and generates a keyword pair of the selected search keywords correlated to each other; and a correlation list generator storing information regarding the generated keyword pair.

In accordance with yet another aspect of the present disclosure, a system for providing information regarding correlated keywords related to search keywords that an advertiser wants to purchase includes: an advertiser interface unit which receives information regarding a first search keyword from a specific advertiser and provides information regarding a set of second search keywords to the specific advertiser, the set of second search keywords being related to the first search keyword; and a correlated keyword management unit which generates a keyword pair of the first search keywords and the second search keyword correlated to each other and provides information regarding the set of second search keyword to the advertiser interface unit in response to a request from the advertiser interface. Here, the second search keyword is a search keyword that a certain advertiser having purchased or attempted to purchase the first search keyword has purchased or attempted to purchase.

Additionally, the present disclosure provide other methods, systems, and a computer readable recording medium for recording a computer program for implementing the method.

### BRIEF DESCRIPTION OF THE DRAWINGS

FIG. 1 shows an overall configuration of a system for generating a keyword pair for search advertisement according to one embodiment of the present disclosure;

FIG. 2 is a block diagram of an internal configuration of a search advertisement system according to one embodiment of the present disclosure;

FIG. 3 is an example of data stored in a history database according to one embodiment of the present disclosure; and

FIG. 4 is an example of a list of correlated keywords provided to an advertiser according to one embodiment of the present disclosure.

### DETAILED DESCRIPTION

Embodiments of the present disclosure will now be described in detail with is reference to the accompanying drawings. The following embodiments are given by way of illustration to provide a thorough understanding of the invention to those skilled in the art. Hence, it should be understood that embodiments of the present disclosure differ from each other but are not exclusive with respect to each other. For example, certain shapes, configurations and features disclosed herein may be realized by other embodiments without departing from the spirit and scope of the invention. Further, it should be understood that positions and arrangement of individual components in each of the embodiments may be changed without departing from the spirit and scope of the invention. Therefore, the following detailed description should not be construed as limiting the claims to a specific embodiment, but should be construed as including all possible embodiments together with the full scope of equivalents to which such claims are entitled. Like elements are denoted by like reference numerals throughout the specification and drawings.

Hereinafter, embodiments of the present disclosure will be described in detail with reference to the accompanying drawings to allow a person having ordinary knowledge in the art to easily implement the present disclosure.

### Exemplary Embodiments

As used herein, the term “search advertisement” generally refers to an advertising is technique or an advertisement provided thereby, which allows advertisement information, for example, a web page address of an advertiser, a single line advertisement message, and an advertising image to appear at a certain position on a search result page when a user searches for information using a certain search keyword through a search engine. In particular, the term “search advertisement” in the present disclosure should be construed as referring to the widest concept including not only search results provided from a search site according to a search keyword input by a user, but also a keyword advertisement allowing a certain advertisement related to the search keyword to be placed on a corresponding web site.

Overall system configuration

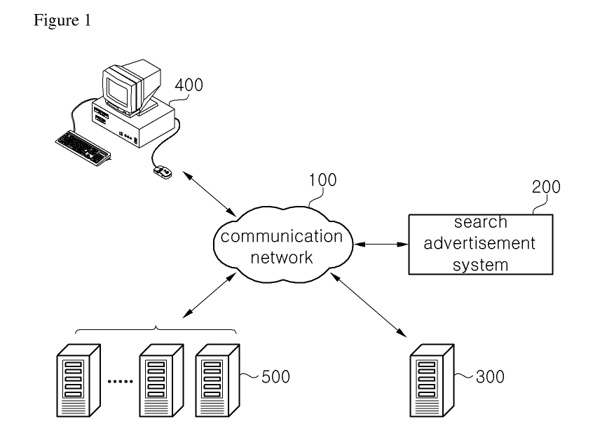

FIG. 1 shows an overall configuration of a system for generating a keyword pair for search advertisement according to an embodiment of the present disclosure.

Referring to FIG. 1, the system according to the embodiment of the present disclosure includes a communication network 100, an advertisement system 200 for generating a keyword pair for search advertisement, an advertiser server (or advertiser terminal) 300, a user terminal 400, a plurality of search servers 500 which retrieve and provide content corresponding to search keywords sent from the user terminal 400 in response to user request.

First, the communication network 100 may be configured in any form, for example, a local area network (LAN), a metropolitan area network (MAN), and a wide area network (WAN so as to realize wired or wireless communication without being limited to a particular form of communication. Preferably, the communication network 100 may be the World Wide Web (WWW) known in the art.

In this embodiment, the search advertisement system 200 may provide a function of allowing an advertiser to inquire about and purchase search advertisements.

Further, according to an embodiment, the search advertisement system 200 may store history information regarding search advertisements that advertisers have purchased, and provide information regarding other search keywords, which are related to a certain search keyword, to an adviser who wants to purchase a search advertisement corresponding to the certain search keyword, based on the history information.

Further, according to an embodiment, the search advertisement system 200 may provide the search servers 500 with a search advertisement which corresponds to a search keyword input to the search servers 500 by a user.

According to an embodiment, the advertiser server 300 may have a function of allowing an advertiser to connect to and communicate with the search advertisement system 200. Here, any digital device, such as personal computers (for example, desktop computers, and notebook computers), work stations, personal digital assistants (PDAs), web pads, and other is mobile communication terminals, may be used as a component of the adviser server 300 or as an advertiser terminal 300 according to the embodiments so long as such device includes a memory and a microprocessor for operation.

Specifically, the advertiser server 300 according to an embodiment may be connected to the search advertisement system 200 to allow an advertiser to purchase a search keyword for placing a search advertisement on the corresponding web site. Such an advertiser server 300 may be a homepage operating server of the advertiser to supply products or services to customers.

According to an embodiment, the user terminal 400 may also have a function of allowing users to connect to and communicate with the search servers 500, and any digital device, such as personal computers (for example, desktop computers, and notebook computers), work stations, personal digital assistants (PDAs), web pads, and other mobile communication terminals, may be used as the user terminal 400 according to the embodiment so long as such device includes a memory and a microprocessor for operation.

According to an embodiment, the search servers 500 communicate with the search advertisement system 200 and/or the user terminal 400. For example, the search servers 500 may be an operating server of an Internet search portal site. Here, the search servers 500 includes a web content search engine (not shown) to store search keywords input by users, search for is content corresponding to the search keywords, and provide a search result to the user terminal 400 to allow the users to browse the search results. Content provided as the search result may include, as an example, information regarding news, knowledge, games, and communities. Of course, as needed, the web content search engine may be included in other operating devices or recording media instead of the search servers 500. Further, although the search advertisement system 200 and the search servers 500 are illustrated as separate components in FIG. 1, the search advertisement system 200 may be included in the search servers 500 providing search services, in the case where a content search service and a search advertisement service are provided together according to needs of those skilled in the art.

Configuration of search advertisement system

Next, the internal configuration and respective components of the search advertisement system 200 will be described in more detail.

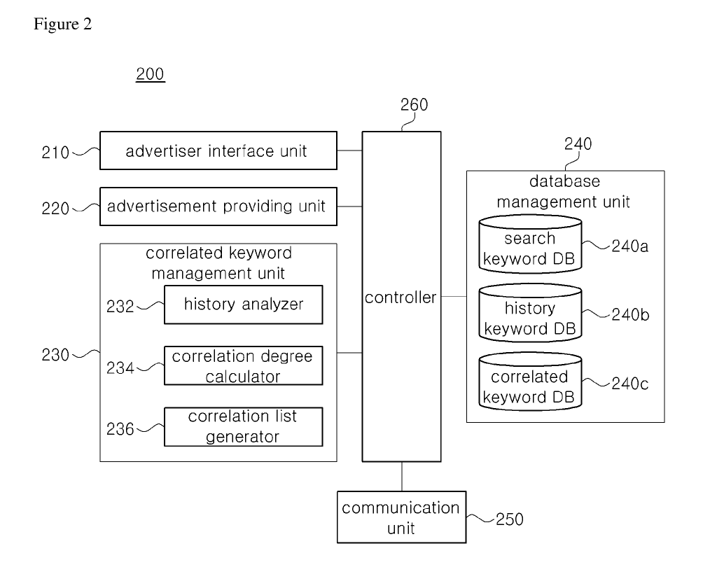

FIG. 2 is a block diagram of the internal configuration of the search advertisement system 200 according to one embodiment of the present disclosure.

Referring to the FIG. 2, the search advertisement system 200 according to the embodiment may include an advertiser interface unit 210, an advertisement providing unit 220, a correlated keyword management unit 230, a database management unit 240, a communication is unit 250, and a controller 260. The correlated keyword management unit 230 may include, for example, a history analyzer 232, a correlation degree calculator 234, a correlation list generator 236. According to an embodiment, at least some of the advertiser interface unit 210, the advertisement providing unit 220, the correlated keyword management unit 230, the database management unit 240, the communication unit 250 and the controller 260 may be program modules communicating with the advertiser server 300, the user terminal 400, and/or the search servers 500. Such program modules may be included in the search advertisement system 200 in the form of operating systems, application program modules, and other program modules, and may be physically stored in several well known storages. Further, the program modules may be stored in a remote storage that can communicate with the search advertisement system 200. On the other hand, the program modules include, but are not limited to, routines, sub-routines, programs, objects, components, and data structures, which perform particular operations or particular abstract data patterns as described below.

First, the advertiser interface unit 210 according to an embodiment may perform a function of providing an interface which allows an advertiser to purchase the right to place search advertisement. More specifically, the advertiser interface unit 210 may provide a function of allowing an advertiser to search for and inquire about a search keyword that the advertiser wants to purchase, a settlement function for purchase of a search keyword, and a function of is managing an account of an advertiser, as an example.

Particularly, according to an embodiment, the advertiser interface unit 210 may receive, from the correlated keyword management unit 230 described below, information regarding a search keyword that an advertiser wants to purchase, acquire information regarding a correlated keyword related to the search keyword from a correlated keyword database 240c described below, and provide the acquired information to the advertiser.

Further, according to an embodiment, the advertiser interface unit 210 may store history of a series of behaviors, performed by advertisers upon inquiry about and purchase of search keywords, in a history database 240b described below.

Next, according to an embodiment, the advertisement providing unit 220 performs a function of providing a search advertisement of an advertiser corresponding to a search keyword input by a user. Specifically, the advertisement providing unit 220 allows the search advertisement of the advertiser purchasing the search keyword to appear together on a corresponding web site when providing a search result corresponding to the search keyword to the user terminal 400.

Next, the correlated keyword management unit 230 according to an embodiment may calculate the degree of correlation between plural keyword pairs and provide information thereof to advertisers.

More specifically, the history analyzer 232 according to an embodiment may extract a list of keywords that advertisers have commonly purchased or attempted to purchase to calculate statistic values thereof with reference to information stored in the history database 240b.

Further, the correlation degree calculator 234 according to an embodiment may perform a function of calculating a correlation value representing relation between the plural keyword pairs based on the statistic values calculated by the history analyzer 232.

Further, the correlation list generator 236 according to an embodiment may generate a list of correlated keywords according to a search keyword based on the correlation value calculated by the correlation degree calculator 234 and may store the list in a correlated keyword database 240c.

The database management unit 240 according to an embodiment may include a search keyword database 240a which stores information of search keywords to be sold to advertisers, a history database 240b which stores history information regarding a series of behaviors performed by advertisers upon inquiry about and purchase of search keywords, and the correlated keyword database 240c storing the list of the correlated keywords according to the search keyword.

The communication module 250 according to an embodiment enables is communication between the search advertisement system 200 and external devices, such as the advertiser server 300, the user terminal 400, and the search servers 500, as an exemplary embodiment.

According to an embodiment, the controller 260 controls a data flow among the advertiser interface unit 210, the advertisement providing unit 220, the correlated keyword management unit 230, the database management unit 240, and the communication unit 250.

In the above description, the database which stores information for realizing the invention is classified into three types of databases, that is, the search keyword database 240a, the history database 240b, and the correlated keyword database 240c. However, it should be noted that the structure of the database including this classification can be varied by way of configurations.

Moreover, it should be understood that the term “database” is used herein includes the concept not only, in a narrow sense, of a database, but also in a broad sense of a database including data records and the like based on computer file systems, and that even a collection of simple processing results may also be included in the database according to the embodiments so long as certain data can be extracted from the collection by searching for the data from the collection.

Generation of keyword pair

According to an embodiment, when an advertiser purchases or attempts to purchase a search keyword using a function provided by the advertiser interface unit 210, a history of such advertiser behavior is stored in the history database 240b.

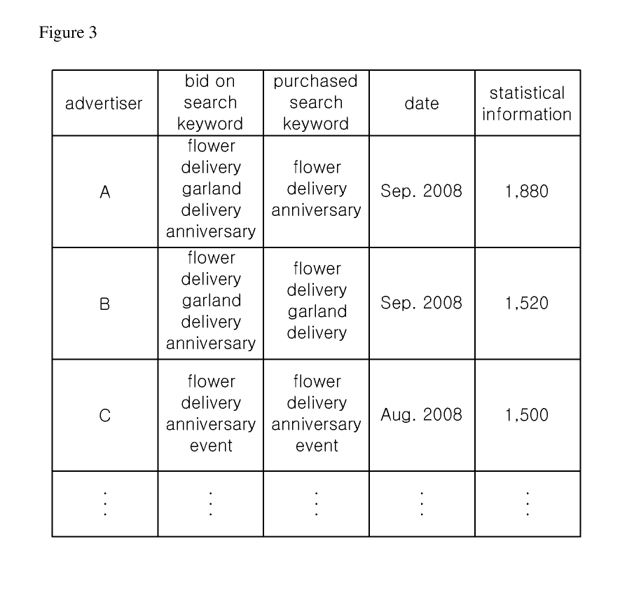

FIG. 3 is an example of data stored in the history database 240b.

Referring to FIG. 3, advertisers A and B bid on search keywords “flower delivery,” “garland delivery” and “anniversary” in September, 2008. Here, the advertiser A bought search keywords of “flower delivery” and “anniversary,” and the advertiser B bought search keywords of “flower delivery” and “garland delivery”. Further, advertiser C bid on and bought the search keywords “flower delivery,” “anniversary,” and “event” in September, 2008.

The history analyzer 232 according to an embodiment may generate keyword pairs with reference to information stored in the history database 240b.

Specifically, in an embodiment, the history analyzer 232 may generate the keyword pairs using information on search keywords that advertisers have actually purchased. In this case, referring to FIG. 3, a keyword pair of (flower delivery, anniversary) may be generated from the history of the advertiser A, a keyword pair of (flower delivery, garland delivery) may be generated from the history of the advertiser B, keyword pairs of (flower delivery, anniversary), (flower delivery, event), and (anniversary, event) may be generated from is the history of the advertiser C.

In another embodiment, the history analyzer 232 may also generate keyword pairs with reference to information of search keywords, which the advertisers did not purchased but attempted to purchase, in addition to search keywords that the advertisers have actually purchased. In this case, a keyword pair of “garland delivery” and “anniversary” may be further added from information of the search keywords on which the advertiser A and B bid, in addition to the keyword pairs described above.

The history analyzer 232 may calculate statistical information on keyword pairs generated as described above. More specifically, the calculated statistical information may be the number of advertisers, from which a certain keyword pair among generated keyword pairs can be deduced. For example, as shown in FIG. 3, when a certain keyword pair is generated using search keywords that advertisers actually purchase, since the keyword pair of “flower delivery” and “anniversary” can be deduced from each of histories of advertiser A and advertiser C, the number of advertisers enabling deduction of the keyword pair of “flower delivery” and “anniversary” is 2. Such statistical information may be deduced based on history information of all advertisers who purchase search keywords.

Since the keyword pair generated as described above is composed of search keywords that one advertiser has purchased or attempted to purchase, it can be understood that is the search keywords of the keyword pair have a predetermined degree of correlation. Next, a method of calculating the degree of correlation between search keywords of a keyword pair will be described.

Calculation of degree of correlation

According to an embodiment, the correlation degree calculator 234 may calculate a degree of correlation between plural keyword pairs based on the statistical information calculated by the history analyzer 232.

The degree of correlation between the search keywords included in the keyword pair may be primarily calculated based on the aforementioned number of common advertisers. In other words, it can be determined that the degree of correlation between the search keywords increases with increasing number of advertisers who purchase all of the search keywords included in the keyword pair.

According to an embodiment, the correlation degree calculator 234 is able to more accurately calculating the degree of correlation between the search keywords included in the keyword pair in consideration of other factors in addition to a number of common advertisers. For example, popularity of the search keywords included in the keyword pair may be further considered. Since the correlated keywords are information provided to the advertisers to assist in is purchasing the search keywords, it can be necessary to consider popularity between general users and/or popularity between advertisers for each search keyword, as described in more detail hereinafter.

Specifically, popularity of a certain search keyword may be measured by accumulating the number of times that users perform searches using the search keyword (so called, query count (qc)). For example, in the case where (“flower delivery,” “garland delivery”) and (“flower delivery,” “anniversary”) are generated as keyword pairs including the search keyword “flower delivery,” if it is found that the search keyword “garland delivery” tends to be more frequently input than the search keyword “anniversary” when referring to histories of the search keywords input to a search engine by general users, it will be calculated that the degree of correlation between “flower delivery” and “garland delivery” is higher than the degree of correlation between “flower delivery”” and “anniversary,” provided that other factors such as the number of common advertisers are the same.

Further, popularity of a certain search keyword may be measured using the number of times that advertisers have purchased or attempted to purchase the search keyword. For example, in the case where (“flower delivery,” “garland delivery”) and (“flower delivery,” “anniversary”) are generated as keyword pairs including the search keyword “flower delivery,” if it is found that the search keyword “garland delivery” tends to be more frequently bought by advertisers than the search keyword “anniversary” when referring to a history of advertiser behavior stored in the history database 240b, it will be calculated that the degree of correlation between “flower delivery” and “garland delivery” is higher than the degree of correlation between “flower delivery” and “anniversary,” provided that other factors such as the number of common advertisers are the same.

In summary, according to an embodiment, popularity of a certain search keyword may be measured in consideration of at least one selected from of times that users perform searches using the search keyword and the number of times that advertisers purchase or attempt to purchase the search keyword.

Although the above description refers to the number of advertisers, popularity among users, popularity among advertisers to obtain the degree of correlation between keywords included in a certain keyword pair, such elements may be calculated by the following Equation 1:

degree of correlation=P(Asp∩Bsp)×P(Bsp)x×P(Bqc)y (1),

where P(Asp∩Bsp) denotes the ratio advertisers purchasing search keywords “A” and “B” at the same time, P(Bsp) denotes the ratio an advertiser purchasing the search keyword “B”, and P(Bqc) denotes the ratio users inputting the search keyword “B” into a search engine. Further, “x” and “y” are values capable of being determined by a manager of the is search advertisement system 200 and may perform a function of properly adjusting the degree of correlation. It should be understood that the method of obtaining the degree of correlation is not limited to Equation 1.

The correlation list generator 236 according to an embodiment may generate a list of correlated keywords for each search keyword, based on the degree of correlation calculated by the correlation degree calculator 234, store the list in the correlated keyword database 240c, and allow the list of correlated keywords to be provided to the advertiser terminal 300 according to an advertiser request.

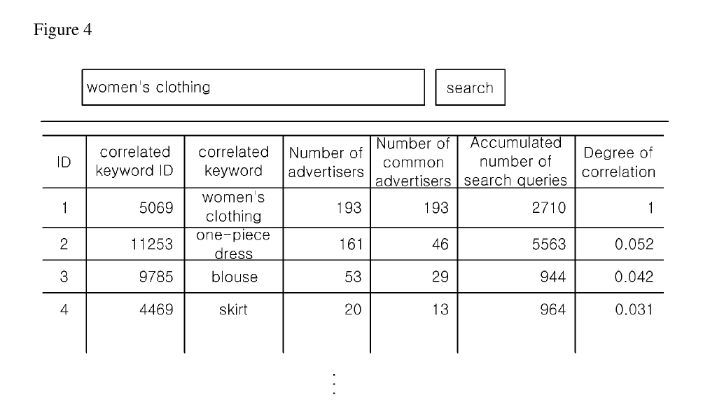

FIG. 4 is an example of a list of correlated keywords generated by Equation 1 and provided to an advertiser according to one embodiment of the present disclosure.

Referring to FIG. 4, it can be seen that, when an advertiser inquires as to a keyword having a high degree of correlation with respect to the keyword “women's clothing” upon purchase of a search keyword, keywords correlated to the keyword “women's clothing” are provided together with the degree of correlation of each of the keywords to the advertiser. For example, referring to FIG. 4, it can be seen that the keyword having the highest degree of correlation with respect to the keyword “women's clothing” is a keyword “one-piece dress” and the degree of correlation calculated by Equation 1 is 0.052. Then, the advertiser may additionally or alternatively buy other search keywords having a relatively high degree of correlation with is respect to the search keyword that the advertiser want to buy, with reference to such a list of correlated keywords.

Although the above discussion refers to the configuration of generating a keyword pair including two search keywords and providing the degree of correlation between the search keywords included in the keyword pair to an advertiser, it should be understood that a target for calculation of the degree of correlation is not necessarily limited to the keyword pair composed of two search keywords and the degree of correlation may also be similarly calculated with respect to a set of keywords including a plurality of search keywords.

The embodiments of the present disclosure may be realized in the form of program instructions which can be implemented through various computer components, and may be recorded in a computer-readable recording medium. The computer-readable recording medium, for example, may include a program instruction, a data file, a data structure, or either alone or in combination thereof. The program instruction recorded in the computer-readable recording medium may be any program instruction particularly designed and structured for the present disclosure or known to those skilled in the field of computer software. Examples of the computer-readable recording medium include magnetic recording media such as hard disks, floppy disks and magnetic tapes, optical data storage media such as CD-ROMs or DVD-ROMs, magneto-optical media such as floptical disks, and hardware devices, such as read-only memory (ROM), random-access memory (RAM), and flash memory, which are particularly structured to store and implement the program instruction. Examples of the program instruction include not only a mechanical language code formatted by a compiler but also a high level language code which can be implemented by a computer using an interpreter. The hardware devices may be configured to be operated by one or more software modules or vice versa to perform the processes according to the present disclosure.

According to the exemplary embodiment of the present disclosure, it is possible to provide an improved keyword determination model capable of determining correlated search keywords without processing an enormous amount of data such as search keywords of all users or keywords appearing on all web pages, thereby enabling more efficient data processing.

According to other embodiments of the present disclosure, the method and system are capable of determining more reasonably correlated search keywords reflecting advertiser preference or purchase pattern.

The various embodiments described above can be combined to provide further embodiments. All of the patents, patent application publications, patent applications, and non-patent publications referred to in this specification and/or listed in the Application Data Sheet are incorporated herein by reference, in their entirety. Aspects of the embodiments can be modified, if necessary, to employ concepts of the various patents, applications and publications to provide is yet further embodiments.

Thus, it should be understood that, while various embodiments have been described above, they have been presented only by way of example, and are not limiting. For instance, an integrated component may be implemented in the form of discrete components, or vice versa.

These and other changes can be made to the embodiments in light of the above-detailed description. In general, in the following claims, the keywords used should not be construed as limiting the claims to the specific embodiments disclosed in the specification and the claims, but should be construed to include all possible embodiments along with the full scope of equivalents to which such claims are entitled. Accordingly, the claims are not limited by the disclosure.

1. A method of generating correlated information between search keywords, the method comprising:
acquiring a set of search keywords for each of advertisers having purchased or attempted to purchase the search keywords to place search advertisement or to make an attempt to place the search advertisement;
selecting at least two search keywords among the set of keywords;
generating a keyword pair of the selected search keywords correlated to each other; and
storing information regarding the generated keyword pair.

2. The method of claim 1, wherein the information regarding the generated keyword pair comprises a degree of correlation between the search keywords included in keyword pair.

3. The method of claim 2, wherein the degree of correlation is determined based on statistical information regarding the keyword pair.

4. The method of claim 3, wherein the statistical information comprises a number of advertisers having purchased or attempted to purchase the search keywords included in keyword pair.

5. The method of claim 4, wherein the degree of correlation is determined by additionally considering a number of times that users perform searches using the search keywords of the keyword pair, a number of times that advertisers have purchased or attempted to purchase the search keywords of the keyword pair, or both the number of times that users perform searches using the search keywords of the keyword pair and the number of times that advertisers have purchased or attempted to purchase the search keywords of the keyword pair.

6. The method of claim 2, further comprising:
providing the information regarding the keyword pair to another advertiser who wants to purchase the search keywords.

7. The method of claim 6, wherein providing the information regarding the keyword pair to another advertiser comprises providing information regarding upper n search keywords having relatively high degrees of correlation with a certain search keyword when the other advertiser inputs the certain search keyword as a query.

8. A method of providing information regarding correlated keywords related to search keywords that an advertiser wants to purchase, the method comprising:
receiving information regarding a first search keyword from a certain advertiser;
acquiring a second search keyword related to the first search keyword, the second search keyword representing a search keyword associated with any other advertiser having purchased or attempted to purchase the first search keyword; and
providing information regarding the acquired second search keyword to the specific advertiser.

9. A system for generating correlated information between search keywords, the system comprising
an advertiser interface unit configured to provide an interface which allows advertisers to purchase the right to place search advertisement therethrough;
a history database configured to store history of a series of behaviors performed by advertisers upon inquiry about and purchase of search keywords through the advertiser interface unit;
a history analyzer configured to acquire, from the history database, a set of search keywords that a certain advertiser has purchased or attempted to purchase, to select at least two search keywords among the set of keywords, and to generate a keyword pair of the selected search keywords correlated to each other; and
a correlation list generator configured to store information regarding the generated keyword pair.

10. The system of claim 9, further comprising:
a correlation degree calculator configured to calculate a degree of correlation between the search keywords included in the keyword pair, the information regarding the generated keyword pair comprising the degree of correlation.

11. The system of claim 10, wherein the correlation degree calculator is configured to calculate the degree of correlation based on statistical information regarding the keyword pair.

12. The system of claim 11, wherein the statistical information comprises the number of advisers having purchased or attempted to purchase the search keywords included in the keyword pair.

13. The system of claim 12, wherein the degree of correlation is determined by additionally considering a number of times that users perform searches using the search keywords of the keyword pair, a number of times that advertisers have purchased or attempted to purchase the search keywords of the keyword pair, or both the number of times that users perform searches using the search keywords of the keyword pair and the number of times that advertisers have purchased or attempted to purchase the search keywords of the keyword pair.

14. The system of claim 10, wherein the advertiser interface unit is configured to provide the information regarding the keyword pair to another advertiser who wants to purchase the search keywords.

15. The system of claim 14, wherein the advertiser interface unit is configured to provide information regarding upper n search keywords having relatively high degrees of correlation with respect to a certain search keyword when the other advertiser input the certain search keyword as a query.

16. A system for providing information regarding correlated keywords related to search keywords that an advertiser wants to purchase, the system comprising:
an advertiser interface unit configured to receive information regarding a first search keyword from a specific advertiser and to provide information regarding a set of second search keywords to the specific advertiser, the set of second search keywords being related to the first search keyword; and
a correlated keyword management unit configured to generate a keyword pair of the first search keywords and the second search keyword correlated to each other and to provide information regarding the set of second search keywords to the advertiser interface unit in response to a request from the advertiser interface, the second search keyword representing a search keyword associated with a certain advertiser having purchased or attempted to purchase the first search keyword.

17. A computer readable recording medium for recording a computer program for implementing the method according to claim 1.
